(19) United States
(12) Patent Application Publication
(10) Pub. No.: US 2004/0172526 A1
(43) Pub. Date: Sep. 2, 2004

(54) Universal loader for portable electronic devices

(76) Inventors: Johnathan P. Tann, San Francisco, CA (US); James P. Tann, Salinas, CA (US); Richard T. Culver, San Jose, CA (US)

Correspondence Address: ORRICK, HERRINGTON & SUTCLIFFE, LLP, 4 PARK PLAZA, SUITE 1600, IRVINE, CA, 92614-2558, US

(21) Appl. No.: 10/377,093

(22) Filed: Feb. 27, 2003

(51) Int. Cl. G06F 15/177

(52) U.S. Cl. 713/2

(57) ABSTRACT

The various embodiments disclosed are generally directed towards systems and methods for loading software from a memory card on to a handheld electronic device. In one aspect of the invention, the memory card includes a plurality of directories, wherein each directory corresponds to a particular type of handheld electronic device. Further, each directory may include a program that the device may search for and execute automatically. The program may either install software onto the device's memory, launch software from the device's memory, or launch software from the memory card.

### FIELD OF THE INVENTION

The various embodiments disclosed herein relate to portable computing and wireless devices, and more particularly to improved systems and methods for loading content onto the portable computing and wireless devices.

### BACKGROUND OF THE INVENTION

The rising popularity of portable/handheld computing devices, such as a device having the PocketPC Operating System (“OS”) or the Palm OS, and wireless devices, such as cellular phones, have led to the rise in demand for content on such devices, e.g., video games, scheduling software, email software, etc.

Qne popular method for loading such content into such devices is through a memory card, such as a Multi-Media Card (“MMC”) or a Compact Flash memory card, which is a small, thin, removable, low powered data storage device. The memory card can be inserted into a handheld device so the device can read the data from the card and either install software from the card into the device's own memory or launch programs from the card.

Many of the different types of portable computing and wireless devices available on the market support the same type of memory card. However, many of these devices will not support the same type of software format. For example, software that supports a handheld device having the Palm OS may not necessarily work or install successfully on a device having the PocketPC Operating System (“OS”).

This may cause inconvenience for a retailer selling such software because the retailer would have to provide a separate card having the same software for each type of device. The retailer would also have to manage more Stock Keeping Units (“SKU's”) for the separate cards, thus increasing administrative overhead. Further, customers are inconvenienced by having to buy separate memory cards for the same software if they have more than one handheld device each of a different type. Further, having to create more cards for the same software will increase the publisher's cost.

Another important issue regarding installing software from memory cards to handheld devices is piracy or unauthorized copying of the software. Software on an MMC memory card, for example, can be easily duplicated if some form of digital rights management (DRM) is not employed. There are a number of different and competing DRM technologies available, and publishers interested in exploiting one of them must consider cost (technology licensing fees), flexibility, robustness, and ease of use for the consumer when they make their choice.

Accordingly, improved systems and methods for loading content from a memory card onto a portable computing and/or wireless device would be desirable. Further, improved systems and methods for preventing content from being copied from the memory card would also be desirable.

### SUMMARY OF THE INVENTION

The various embodiments disclosed herein are generally directed towards systems and methods for loading software from a memory card on to a handheld electronic device. In one aspect of the invention, the memory card includes a plurality of directories, wherein each directory corresponds to a particular type of handheld electronic device. Further, each directory may include a program that the device may search for and execute automatically. The program may either install software onto the device's memory, launch software from the device's memory, or launch software from the memory card.

In another aspect of the invention, a program checks to see if the program resides on an authentic memory card. If not, then the program may terminate itself, prevent installation, or restrict its execution.

### BRIEF DESCRIPTION OF THE DRAWINGS

In order to better appreciate how the above-recited and other advantages and objects of the present inventions disclosed herein are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is an illustration of a file directory in accordance with a preferred embodiment of the present invention.

FIG. 2 is a flowchart of an installation process in accordance with an embodiment of the present invention.

FIG. 3 is a flowchart of a program in accordance with an embodiment of the present invention.

FIG. 4 is a flowchart of a program in accordance with an embodiment of the present invention.

FIG. 5 is a flowchart of a software security method in accordance with an embodiment of the present invention.

### DETAILED DESCRIPTION OF THE PREFERRED EMBODIMENTS

Though many different types of handheld electronic devices, such as handheld computing devices and wireless devices, support the same type of memory card, such as the MMC, they may not necessarily support the same type of software code or format. For example, software that supports a handheld device having the Palm Operating System (“OS”) may not necessarily install successfully on a device having the Pocket PC OS. But in many cases, it is desirable to have a single memory card that is capable of successfully installing a particular program on a plurality of different types of handheld electronic devices. Further, it may be desirable to have the single memory card install the program automatically, once the memory card is inserted into a device. Thus, no matter what kind of handheld device the user has, the user can insert the memory card into the device and successfully run or install the program.

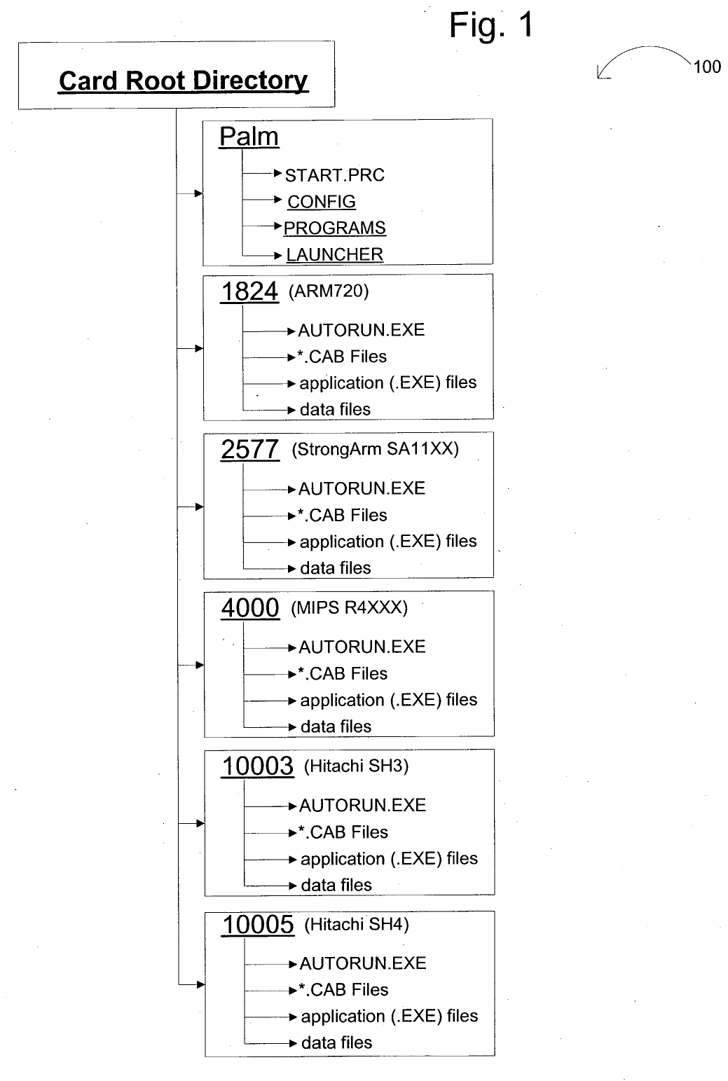

One approach for achieving this is illustrated in FIG. 1, which shows a file directory 100 in accordance with an embodiment of the present invention. Generally, when a memory card is inserted into a particular handheld electronic device, the device automatically looks for a particular directory. For example, a handheld device having the Palm OS will automatically look for a directory labeled “Palm”. Each type of device will look for a respective directory. Further, these devices will generally look for a particular file, which could be a program or a data file-a file that contains data. If a device is looking for a program, and that program exists, then the device will execute or run the program. If the device is looking for a data file, and that file exists, then the device will read the data file for instructions on launching or installing a particular program. For example, if the device has the Palm OS, then it will search for a directory called “Palm”, and within that directory the device will look for and execute a program called “start.prc.”

In light of this, one solution is to include all such directories and files in a single memory card. In FIG. 1, the file directory 100 includes six subdirectories off of the Card's Root Directory labeled: Palm, 1824, 2577, 4000, 10003, and 10005. Each subdirectory corresponds to a particular type of handheld device, i.e., Palm corresponds to a device having the Palm OS, 1824 corresponds to a handheld device having an ARM 720 central processing unit (“CPU”), 2577 corresponds to a handheld device having a CPU from the Strong Arm SA1 XX family of CPU's, 4000 corresponds to a handheld device having a CPU from the MIPS R4XXX family of CPU's, 10003 corresponds to a handheld device having a Hitachi SH3 CPU, and 10005 corresponds to a handheld device having a Hitachi SH4 CPU. An embodiment in accordance with the present invention may include any number of these directories and may include directories not listed above.

Each subdirectory includes the file that the corresponding handheld device will look for when the memory card is inserted into the device. For example, if an MMC is inserted into a handheld device with the Arm 720 CPU having the PocketPC OS, then the device will look for a program called “autorun.exe” in the 1824 subdirectory. If found, then the device will launch or run the autorun.exe program. This program will be described in more detail below.

Each subdirectory further includes the software that the user wants to run or install on the user's device. For software that is intended to be installed on a handheld device having the PocketPC OS, i.e., if the software is intended to be copied onto the device's memory, then the software is usually put in the respective subdirectory in the form of *.cab files. For example, subdirectories 1824, 2577, 4000, 10003, and 10005 each have the software in the form of *.cab files. *.cab files are generally compressed forms of the software, to save disk space on the memory card. The files are “expanded” into executable form when they are copied into the handheld device's memory. If the software is intended to be launched or executed from the memory card and not from the handheld device's memory, then the software is usually put in the respective subdirectory as an executable, e.g., *.exe file.

Often, the software may also have corresponding data files that provide specific instructions, parameters, or general data for installing or executing the software on the device, and the software may further have corresponding or supplemental executable files, e.g., *.exe files. Further, these data files, or components of these data files, may be shared by different devices having different OS's, thus saving space on the memory card by not requiring duplicates of the same data files. For example, an electronic book could have multiple readers, each using the same memory card for data. These readers may share the same data file(s) in the memory card, such as a single data file containing text for the electronic book, even if the readers have different OS platforms.

For devices having the Palm OS, the corresponding directory may include files analogous to the files described for devices with a PocketPC OS, i.e., the Palm subdirectory may include software to be launched or installed into the device's memory, located in a subdirectory labeled as “programs” in FIG. 1, data files that provide specific parameters when installing or launching the software, located in a subdirectory labeled as “config,” and corresponding or supplemental executable files, located in a subdirectory labeled as “launcher.”

With a memory card having the file directory 100 and the corresponding files described above, a user can insert the memory card into any of the devices listed above and still be able to successfully install or run the desired software.

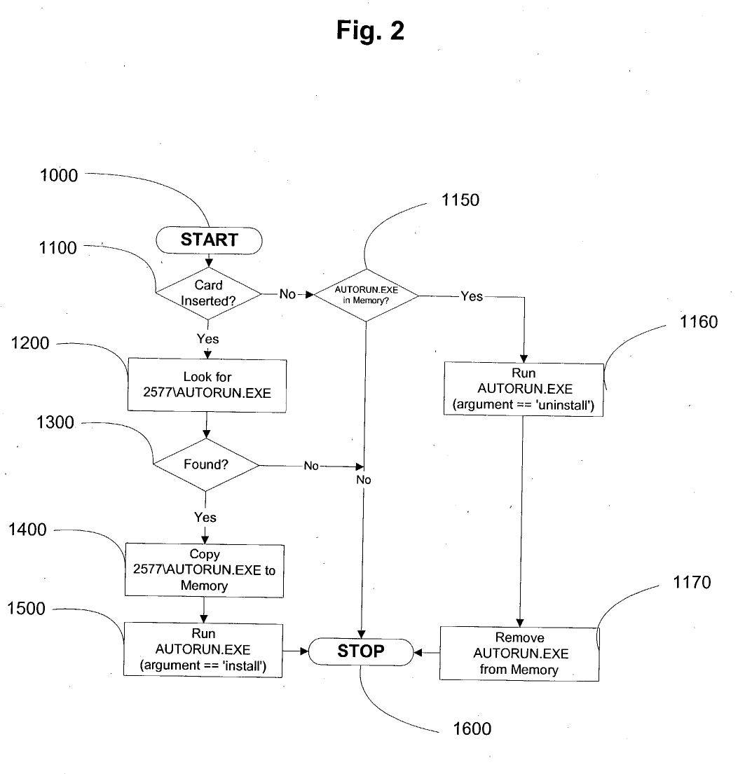

Turning to FIG. 2, a flowchart illustrating how a handheld computing device having the PocketPC OS and a StrongArm SX1 lXX CPU handles a memory card having the file directory 100 structure described above is shown. When the memory card having desired software to be installed is inserted into the device (starting block 1000), the device detects whether the card is inserted (decision block 1100). If the device is not inserted, then the device searches to see if there is a program available in its own memory called autorun.exe (decision block 1150). If not, then the device stops the search and continues its normal operation (stop block 1600). If there is an autorun.exe program available, then that signifies that the memory card was at one point inserted into the device, because the autorun.exe program was copied from the memory card, but then the memory card was removed before software could be installed. In this case, the device will run autorun.exe, passing “uninstall” as an argument (action block 1160). The program will respond to the uninstall argument, remove itself from the device's memory, and terminate (action block 1170). The device will then continue its normal operation (stop block 1600).

If the device does detect a memory card (decision block 1100), then the device will search for autorun.exe in the 2577 subdirectory (action block 1200). If the program was not found (decision block 1300), then the device will continue its normal operation (stop block 1600). The user can then execute the installation program or launch programs for the memory card. If the autorun.exe was found (decision block 1300), then the device will copy autorun.exe into its memory (action block 1400). Then, the device will execute autorun.exe, passing “install” as an argument (action block 1500). In response to the install argument, the program will proceed to install the desired software from the memory card into the device's memory and launch any desired application, then continue its normal operation (stop block 1600).

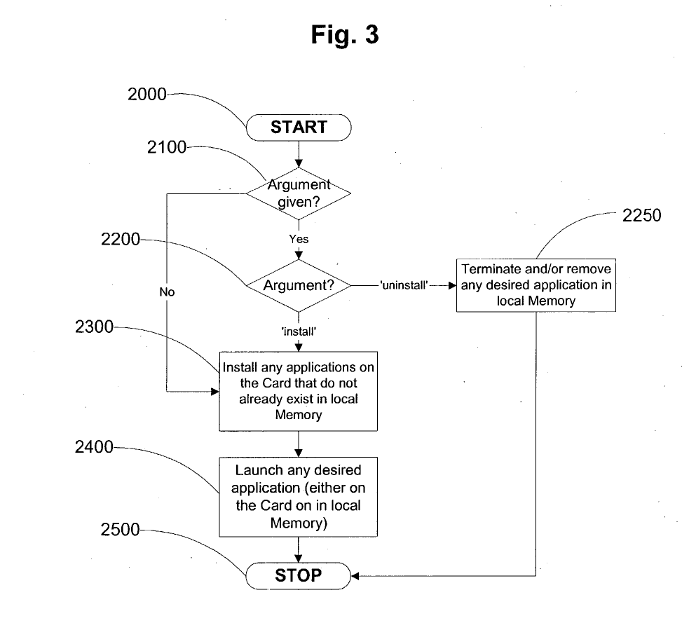

The framework or shell for autorun.exe is provided by Microsoft and can be found at: http://msdn.microsoft.com/library/default.asp?url=/library/enus/w esetup/htm/_wcesdk_using_autorun_on the_pocket_pc.asp. The framework only provides source code for automatically installing an application, but does not provide source code for launching other applications. However, as can be appreciated by one of ordinary skill in the art, since the source code is available, a programmer can enhance the code and add new features. Turning to FIG. 3, a flowchart is shown, illustrating how autorun.exe can be enhanced to not only install an application, but also launch any desired application. When a memory card having desired software is inserted into a handheld device, the device looks for the corresponding subdirectory and launches the autorun.exe program in that directory if it exists. When the autorun.exe is launched (start block 2000), the program checks to see if an argument is passed (decision block 2100). Generally, when a PocketPC device launches autorun.exe, it checks to see if the memory card is still properly inserted into the device. If so, then the device will pass an “install” argument to autorun.exe to proceed with the installation process. If not, e.g., if someone prematurely removed the memory card, then the device will pass an “uninstall” argument to autorun.exe to instruct the autorun.exe program to terminate and remove itself from memory.

There are some PocketPC or Smart Phone devices that do not pass an argument to autorun.exe. In this case, the autorun.exe program will proceed with the installation process (action block 2300), i.e., the autorun.exe will install the desired software from the memory card that does not already exist in the memory of the device. Autorun.exe will further launch any desired application, from the memory card or from the device's memory. If an argument is passed (decision block 2100), then autorun.exe will check the argument (decision block 2200). If the argument passed is uninstall, then autorun.exe will terminate and remove itself and any desired application from the device's memory (action block 2250). If the argument passed is install (decision block 2200), then the autorun.exe will install any application, including the desired software, from the memory card to the memory of the device that do not already exist (action block 2300). Further, autorun.exe will launch any desired application, either from the memory card or the device's memory (action block 2400). For example, the corresponding subdirectory may include the Internet Explorer program. The autorun.exe can be coded to automatically launch the Internet Explorer program within the device from the memory card and have the Explorer point to any desired page.

The ability to control the autorun.exe to launch any application and control how the autorun.exe launches a program provides flexibility to the user as well as the party that prepares the content, i.e., the desired software on the memory card. For the user, the autorun.exe may launch a graphical menu, e.g., a web page, from the memory card that allows to the user to select which applications to install or launch, or which features of the application to install or launch. For the party creating or preparing the content for the memory card, the party can determine how programs are launched from the memory card, i.e., the party can customize the installation and launch of the software. For example, autorun.exe can be configured to launch a program from the memory card or the device's memory. In another example, autorun.exe can be configured to allow a user to control the installation, as described above, or hide the control from the user. Further, the party may have the autorun.exe load configurable “splash screens” that display marketing information and logos for a certain period of time. Subsequently, the device will continue with its normal operation (stop block 2500).

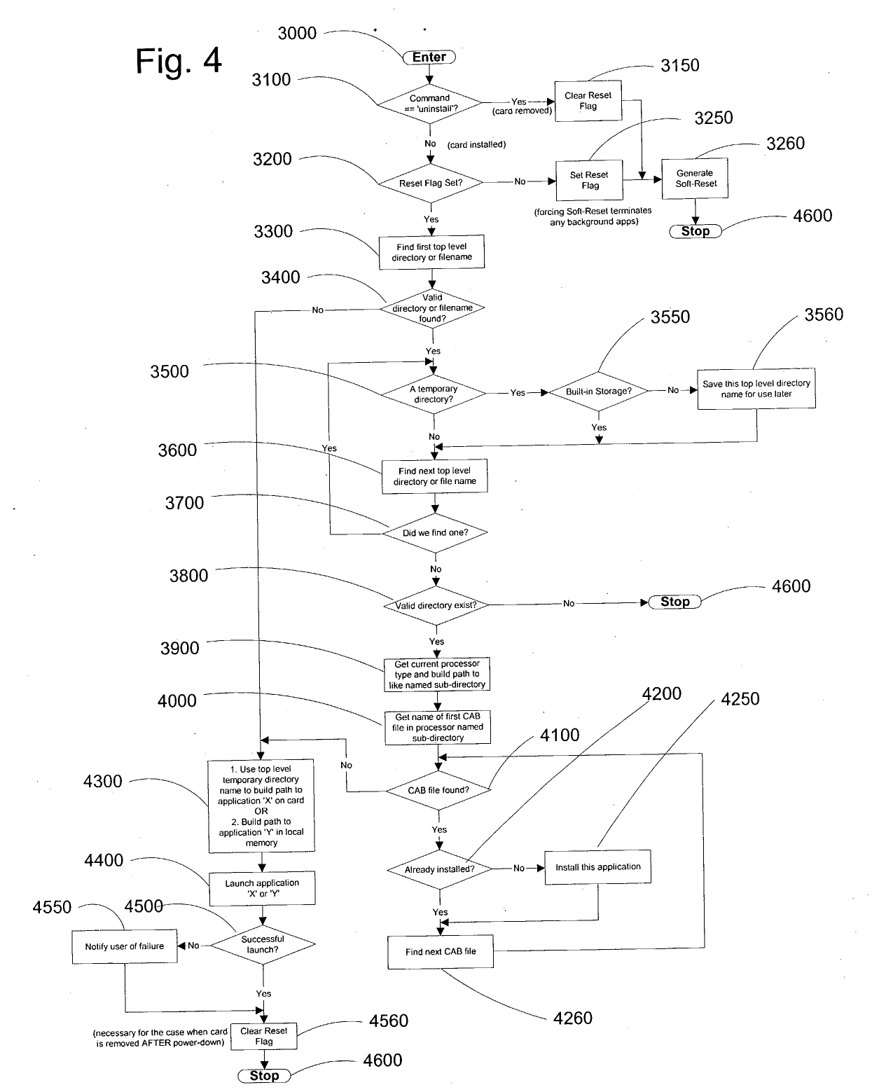

Turning to FIG. 4, a detailed flowchart of an implementation of autorun.exe is shown. When a memory card having software is inserted into a device having the PocketPC OS, the device will search for the respective directory and search for autorun.exe in the respective directory. If found, the device will launch autorun.exe (enter block 3000). Autorun.exe will first check to see if an “uninstall” argument has been passed (decision block 3100). If so, then that indicates that the memory card has been removed from the device and autorun.exe will clear a “reset flag” (action block 3150). The reset flag will indicate whether the autorun.exe should install software onto the memory's device. If the autorun.exe is instructed to not install the software, it may be because the memory card is not available or the software has already been installed. Subsequently, autorun.exe will perform a “soft-reset”, wherein it will reboot the Pocket PC device (action block 3260) and then terminate itself without removing any files from the device's memory (action block 4600).

Turning back to decision block 3100, if the uninstall argument was not passed, then that indicates that the memory card is still inserted into the device. Autorun.exe will then check if the reset flag was set (decision block 3200). If it was not set, then autorun.exe will set the reset flag (action block 3250), perform a soft-reset (action block 3260) and then terminate itself (action block 4600). If the reset flag was set (decision block 3200), then autorun.exe will search for the first top level directory or filename in the device's memory (action block 3300). If there is no valid directory or filename found (decision block 3400), then autorun.exe will either use a top level temporary directory name to build a path to a particular application on the memory card, or it will build a path to a particular application already in the device's memory, depending on how the installation process is prepared and how autorun.exe is programmed and configured (action block 4300). Subsequently, autorun.exe will launch the particular application, either from the device's memory or from the memory card (action block 4400). If there was a successful launch (decision block 4500), then autorun.exe will clear the reset flag (action block 4560), which is necessary for the case when the memory card is removed from the device after the device powers down. Autorun.exe will then close itself or terminate itself (stop block 4600). If the launch was not successful, then autorun.exe will notify the user of the failure, e.g., through a graphical window that pops up in the display of the device.

Turning back to decision block 3400, if there is a valid directory or filename found, then autorun.exe checks if the directory is a temporary directory (decision block 3500), e.g., a directory located on a removable flash, ROM, or Micro Drive memory card. If it is a temporary directory, then the program checks if there is built-in storage (decision block 3550) because sometimes the temporary directory, i.e., the removable flash or ROM memory card, is actually built-in or permanent in the device. If it is not built-in storage, then the directory name is saved for later use (action block 3560) and then autorun.exe will search for the next top level directory or file name (action block 3600). If the temporary directory is built-in storage, then autorun.exe will search for the next top level directory or file name (action block 3600). Turning back to decision block 3500, if the valid directory or file name found is not a temporary directory, then autorun.exe will proceed to search for the next top level directory or file name (action block 3600). If one is found (decision block 3700), then autorun.exe will go back to decision block -3500 to determine if it is a temporary directory. If autorun.exe does not find a subsequent top level directory or file name (decision block 3700), then it will check to see if a valid directory does indeed exist (decision block 3800). If none exists, then there is a problem, e.g., no card is inserted, so it will terminate itself (stop block 4600).

If a valid directory does exist (decision block 3800), then autorun.exe will determine the current processor type and build a path to the valid directory, which could be either on a memory card, either the memory card that originated the autorun.exe or another memory card, or in the device's memory (action block 3900). Next, the program gets the name of the first *.cab file from a corresponding subdirectory, e.g., from the subdirectory on the memory card originating the autorun.exe corresponding to the device the card is inserted into, such as a subdirectory labeled “2577” if the device the memory card is inserted into has a StrongArm SA1 lXX CPU (action block 4000). If the *.cab file is not found (decision block 4100), then it is possible that the program has already been installed or that there are no *.cab files to install, so the program will try to launch an application. The program will go to action block 4300, i.e., it will either use a top level temporary directory name to build a path to a particular application on the memory card, or it will build a path to a particular application already in the device's memory, depending on how the installation process is prepared and how autorun.exe is programmed and configured. If a *.cab file is found (decision block 4100), then the program checks if the contents of the *.cab file have already been installed on the device's memory (decision block 4200). If not, then the contents of the *.cab file will be installed on the device's memory in the valid directory (action block 4250). If so, then the program will not install the contents in the *.cab file and proceed to find the next *.cab file (action block 4260) and repeated decision block 4100.

It should be noted that the principles applied to autorun.exe above may be equally applied to any executable program designed to automatically install or execute software in a handheld electronic device from a memory card.

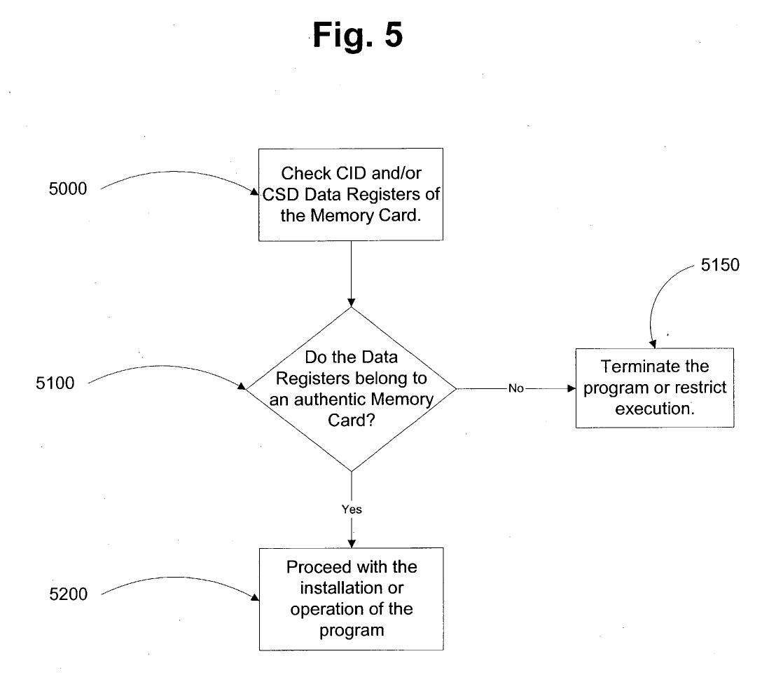

Another issue in regards to installing software from memory cards onto handheld electronic devices is security, more particularly, preventing piracy or unauthorized copying of the software. Typically, MMC and Security Digital (“SD”) Read Only Memory (“ROM”) and flash memory cards include specific resident data registers, Card Identification (“CID”) and Card Specific Data (“CSD”), which provides information such as how to access card contents. These data registers have data fields unique to a particular memory card. Turning to FIG. 5, a flowchart illustrating a security system using the data registers in the memory card is illustrated. By examining the unique data field values (action block 5000), a program can determine if the software that is about to be installed or launched came from an authentic memory card (decision block 5100). If the memory card cannot be authenticated, the software can be instructed to terminate, prevent installation, and/or restrict its execution, e.g., run in a demo mode (action block 5150). If the memory card can be authenticated, then the installation or execution of the software may continue (action block 5200).

A program can check five fields of data in the CID register and three from the CSD register to determine the authenticity of the MMC ROM or flash memory card being used.

Those fields are as follows:

CID Register Fields:

1. The MID (Manufacturer ID) field is an 8-bit binary number controlled and assigned to each manufacturer by the Multi-Media Card Association (“MMCA”). Using another manufacturer's MID is strictly prohibited and subject to legal action by the MMCA for non-compliance. The MID of the authorized MMC Read Only Memory (“ROM”) card manufacturer is a good first data check for the card's authenticity.

2. The OID (OEM ID) field is a 16-bit number that is controlled and assigned by the MMCA. While this number is not generally used, a single number can be assigned to the content producer by the MMCA if so requested.

3. The PNM (Product Name) field is controlled and assigned by the MMC ROM manufacturer. This field is not “writeable” per the MMCA specification, and commercially available MMC flash cards will not be able to duplicate it.

4. The PRV (Product Revision) field is controlled and assigned by the MMC ROM manufacturer. This field is not “writeable” per the MMCA specification, and commercially available MMC flash cards will not be able to duplicate it.

5. The PSN (Product Serial Number) field is controlled and assigned by the MMC ROM manufacturer. This field is not “writeable” per the MMCA specification, and commercially available MMC flash cards will not be able to duplicate it. Additionally, every MMC flash card has a unique PSN assigned by the MMC flash manufacturer, so no two MMC flash cards will be identical. Keying off of this field alone might be sufficient protection for some content producers. CSD Register Fields:

1. The CCC (Card Command Class) field is useful for MMC ROM identification because MMC ROM cards do not support any command classes above Class 2; MMC flash cards do. 2. The size of the card can be computed (device size, device size multiplier, & read block length), and it must match the size of the authentic MMC ROM card used for distribution.

All of the above data check points or any combination of them may be used to validate the authenticity of the MMC card being used.

It should be pointed out that some operating systems (OS) are not able to send all of the above data fields to a content producer's application. The producer is urged to consult the Application Programming Interface function calls available for the specific OS platform being targeted.

As mentioned above, the various embodiments disclosed herein may take the form of a computer program comprising a series of instructions. These instructions may be supplied on other computer usable media, in addition to MMC and SD memory cards, which may include, for example: a floppy disk, flexible disk, hard disk, magnetic tape, any other magnetic medium, CD-ROM, any other optical medium, punchcards, papertape, any other physical medium with patterns of holes, RAM, ROM, PROM (i.e., programmable read only memory), EPROM (i.e., erasable programmable read only memory), including FLASH-EPROM, any other memory chip or cartridge, carrier waves, or any other medium.

Although particular embodiments of the present inventions have been shown and described, it will be understood that it is not intended to limit the present inventions to the preferred embodiments, and it will be obvious to those skilled in the art that various changes and modifications may be made without departing from the spirit and scope of the present inventions. Thus, the present inventions are intended to cover alternatives, modifications, and equivalents, which may be included within the spirit and scope of the present inventions as defined by the claims.

What is claimed is:

1. A loader for a memory card, capable of loading software onto a plurality of different types of portable electronic devices, comprising:
a plurality of directories created in the memory card, each directory corresponding to a particular type of portable electronic device; and
a program located in each directory, wherein when the memory card is plugged into a particular type of portable electronic device, the program in the directory corresponding to the type of portable electronic device will execute automatically.

2. The loader in claim 1, wherein the program will install software onto the portable electronic device.

3. The loader in claim 1, wherein the program will launch particular software on the portable electronic device.

4. The loader in claim 3, wherein the particular software is a menu that provides a user with options for installing other software on the portable electronic device.

5. The loader in claim 4, wherein the options include specifying which other software to install on the portable electronic device.

6. The loader in claim 1, wherein the program is called autorun.exe.

7. The loader in claim 1, wherein the program is capable of detecting whether the memory card has been removed from the portable electronic device while the program is running and capable of executing particular clean up routines.

8. The loader in claim 7, wherein the clean up routines include stop the running task and purge device memory.

9. The loader in claim 1, wherein the program is capable of being configured to determine how to install the particular software on the portable electronic device.

10. The loader in claim 1, wherein the program is capable of being configured to determine how to launch the particular software on the portable electronic device.

11. The loader in claim 1, wherein the names of the plurality of directories include palm, 1824, 2577, 4000, 10003, and 10005.

12. A method for setting up a memory card to be capable of supporting a plurality of types of portable electronic devices, comprising the steps of:
creating a plurality of directories on the memory card, wherein each directory corresponds to a particular type of portable electronic device; and
installing a program in each directory, wherein when the memory card is inserted into a particular type of portable electronic device, the program in the directory corresponding to the particular type of portable electronic device will automatically launch.

13. A method for preventing unauthorized copying of programs from a memory card, having data registers, inserted into a portable electronic device, comprising the steps of:
checking the data registers of the memory card; and
determining whether the data registers belong to an authentic memory card.

14. The method of claim 13, further comprising the step of preventing the execution of the programs if the data registers do not belong to an authentic memory card.

15. The method of claim 13, further comprising the step of limiting the execution of the programs if the data registers do not belong to an authentic memory card.

16. The method of claim 13, wherein the data registers include values corresponding to the card identification.

17. The method of claim 13, wherein the data registers include values corresponding to card specific data.

18. A computer program product that includes a computer-usable medium having a sequence of instructions which, when executed by a processor, causes said processor to execute a process for preventing unauthorized copying of programs from a memory card, having data registers, inserted into a portable electronic device, said process comprising:
checking the data registers of the memory card; and determining whether the data registers belong to an authentic memory card.

19. The computer program product of claim 18, further comprising preventing the execution of the programs if the data registers do not belong to an authentic memory card.

20. The computer program product of claim 18, further comprising the step of limiting the execution of the programs if the data registers do not belong to an authentic memory card.

21. The computer program product of claim 18, wherein the data registers include values corresponding to the card identification.

22. The computer program product of claim 18, wherein the data registers include values corresponding to card specific data.
